(19) United States
(12) Patent Application Publication
(10) Pub. No.: US 2024/0186526 A1
(43) Pub. Date: Jun. 6, 2024

(54) COPPER FOIL, ELECTRODE COMPRISING THE SAME, SECONDARY BATTERY COMPRISING THE SAME, AND METHOD FOR MANUFACTURING THE SAME

(71) Applicant: SK NEXILIS CO., LTD., Jeongeup-si Jeollabuk-do (KR)

(72) Inventors: Shan Hua JIN, Jeongeup-si Jeollabuk-do (KR); Min Seok YOON, Jeongeup-si Jeollabuk-do (KR)

(21) Appl. No.: 18/529,310

(22) Filed: Dec. 5, 2023

(30) Foreign Application Priority Data
Dec. 6, 2022 (KR) 10-2022-0168761
Oct. 5, 2023 (KR) 10-2023-0132907

(51) Int. Cl. H01M 4/66; H01M 4/75

(52) U.S. Cl. CPC H01M 4/661; H01M 4/667; H01M 4/75; H01M 2004/027

(57) ABSTRACT

According to one embodiment of the present disclosure, there is provided a copper foil including a copper film including 99.9 wt % or more of copper, and a protective layer formed on the copper film, wherein the copper foil has a room temperature water contact angle in a range of 60° to 70°, and a room temperature surface resistivity in a range of 2.4 mΩ/cm to 2.7 mΩ/cm.

### CROSS-REFERENCE TO RELATED APPLICATIONS

This application claims the benefit of the Korean Patent Applications No. 10-2022-0168761 filed on Dec. 6, 2022 and No. 10-2023-0132907 filed on Oct. 5, 2023, which are hereby incorporated by reference as if fully set forth herein.

### FIELD

The present disclosure relates to a copper foil, an electrode including the same, a secondary battery including the same, and a method for manufacturing the same.

### BACKGROUND

Secondary batteries are types of energy conversion devices that convert electrical energy into chemical energy, store the chemical energy therein, and then convert the chemical energy back to electrical energy when electricity is needed, thereby generating electricity. The secondary batteries are used as energy sources for electric vehicles as well as portable home appliances such as mobile phones, laptop computers, and the like. The secondary batteries are rechargeable and thus are also referred to as rechargeable batteries.

As secondary batteries that have economic and environmental advantages over disposable primary batteries, there are lead-acid batteries, nickel-cadmium secondary batteries, nickel-hydrogen secondary batteries, and lithium secondary batteries.

In particular, lithium secondary batteries may store a relatively large amount of energy relative to their size and weight compared with other secondary batteries. Accordingly, in the field of information communication devices in which portability and mobility are important, the lithium secondary batteries are preferred, and an application range thereof is also expanding to energy storage devices for hybrid vehicles and electric vehicles.

Lithium secondary batteries are repeatedly used through one cycle of charging and discharging. When a certain device is operated with a fully charged lithium secondary battery, the lithium secondary battery should have a high charge/discharge capacity in order to increase the operating time of the device. Accordingly, research to satisfy ever-increasing expectations (needs) of consumers regarding the charge/discharge capacity of a lithium secondary battery is continuously required.

Such a secondary battery includes an anode current collector made of a copper foil, and among copper foils, an electrolytic copper foil is widely used as an anode current collector of a secondary battery. Along with an increase in demand for secondary batteries, there is an increase in demand for secondary batteries with high capacity, high efficiency, and high quality, and thus, there is a need for copper foils capable of improving characteristics of secondary batteries. In particular, there is a need for copper foils that can ensure high capacity to secondary batteries and enable secondary batteries to stably maintain capacity and performance.

### SUMMARY

Accordingly, the present disclosure relates to a copper foil capable of preventing the problems caused by the limitations and disadvantages of the related art described above, an electrode including the same, a secondary battery including the same, and a method for manufacturing the same.

According to one embodiment of the present disclosure, there is provided a copper foil with improved conductivity by having a room temperature water contact angle in a range of 60° to 70°.

According to another embodiment of the present disclosure, there is provided a copper foil with improved conductivity by having a room temperature surface resistivity in a range of 2.4 mΩ/cm to 2.7 mΩ/cm.

According to still another embodiment of the present disclosure, there is provided a copper foil that maintains high conductivity even after heat treatment by having a water contact angle reduction rate in a range of 0% to 25% after heat treatment at 190° C. for one hour.

According to yet another embodiment of the present disclosure, there is provided a copper foil that maintains high conductivity even after heat treatment by having a surface resistance increase rate in a range of 0% to 5% after heat treatment at 190° C. for one hour.

According to yet another embodiment of the present disclosure, there is provided an electrode capable of ensuring high productivity by being manufactured with a copper foil having improved conductivity during a roll-to-roll (RTR) process.

According to yet another embodiment of the present disclosure, there is provided a secondary battery capable of ensuring high productivity by being manufactured with a copper foil having improved conductivity during an RTR process.

According to yet another embodiment of the present disclosure, there is provided a method for manufacturing a copper foil with improved conductivity during an RTR process by having a room temperature water contact angle in a range of 60° to 70° and a room temperature surface resistivity in a range of 2.4 mΩ/cm to 2.7 mΩ/cm.

In addition to the aspects of the present disclosure described above, other features and advantages of the present disclosure will be described in the following detailed description, or may be clearly understood by those skilled in the art to which the present disclosure pertains from such description.

According to one embodiment of the present disclosure, there is provided a copper foil including a copper film including 99.9 wt % or more of copper, and a protective layer formed on the copper film, wherein the copper foil has a room temperature water contact angle in a range of 60° to 70°, and a room temperature surface resistivity in a range of 2.4 mΩ/cm to 2.7 mΩ/cm.

According to another embodiment of the present disclosure, there is provided a method for manufacturing a copper foil, the method including forming a copper film, and forming a protective layer on the copper film, wherein the forming of the copper film includes forming the copper film on a rotating anode drum by electrically connecting a cathode plate and the rotating anode drum, which are disposed to be spaced apart from each other in an electrolyte in an electrolytic bath, and the electrolyte includes copper ions at a concentration of 70 g/L to 100 g/L, sulfuric acid at a concentration of 70 g/L to 150 g/L, chlorine (Cl) at a concentration of 1 ppm to 3 ppm, hydrogen peroxide at a concentration of 1 ml/L to 10 ml/L, lead ions at a concentration of 1 ppm to 20 ppm, silver ions at a concentration of 0.1 ppm to 1 ppm, and cerium ions (Ce²⁺) at a concentration of 2 ppm to 10 ppm.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is a cross-sectional view of a copper foil according to one embodiment of the present disclosure;

FIG. 2 is a cross-sectional view of an electrode for a secondary battery according to another embodiment of the present disclosure;

FIG. 3 is a schematic cross-sectional view of a secondary battery according to still another embodiment of the present disclosure; and

FIG. 4 is a device for manufacturing a copper foil according to yet another embodiment of the present disclosure.

### DETAILED DESCRIPTION

Hereinafter, embodiments of the present disclosure will be described in detail with reference to the accompanying drawings. However, the embodiments described below are presented only for illustrative purposes to facilitate a clear understanding of the present disclosure and do not limit the scope of the present disclosure.

Shapes, sizes, ratios, angles, numbers, and the like disclosed in the drawings for describing the embodiments of the present disclosure are illustrative, and thus the present disclosure is not limited to the details illustrated in the drawings. Throughout the present specification, the same components may be referred to by the same reference numerals. In describing the present disclosure, detailed descriptions of related known technologies will be omitted when it is determined that they may unnecessarily obscure the gist of the present disclosure.

When terms “including,” “having,” “consisting of,” and the like described in the present specification are used, other parts may be added unless the term “only” is used herein. When a component is expressed in the singular form, the plural form is included unless otherwise specified. In addition, in interpreting a component, it is interpreted as including an error range even when not explicitly stated.

In describing a positional relationship, for example, when a positional relationship of two parts is described as being “on,” “above,” “below, “next to,” or the like, unless “immediately” or “directly” is used, one or more other parts may be located between the two parts.

Spatially relative terms, such as “below,” “beneath,” “lower,” “above,” “upper” and the like, may be used herein for ease of description to describe one element or component's relationship to another element(s) or component(s) as illustrated in the drawings. It will be understood that the spatially relative terms are intended to include different orientations of the element in use or operation in addition to the orientation illustrated in the drawings. For example, when an element in the drawings is turned over, an element described as being “above” or “upper” relative to another element will then be “below” or “lower” relative to the other element. Thus, the exemplary term “below” may include both above and below orientations. Likewise, the exemplary terms “above” or “upper” may include both above and below orientations.

In describing a temporal relationship, for example, when a temporal relationship is described as being “after,” “subsequent,” “next to,” “prior to,” or the like, unless “immediately” or “directly” is used, cases that are not continuous may also be included.

In order to describe various components, terms such as “first,” “second,” and the like are used, but these components are not limited by these terms. These terms are only used to distinguish one component from another component. Therefore, a first component described below may be a second component within the technical spirit of the present disclosure.

The term “at least one” should be understood to include all possible combinations from one or more related items. For example, the meaning of “at least one of first, second, and third items” may mean all combinations of two or more items of the first, second and third items as well as each of the first, second and third items.

The features of various embodiments of the present disclosure may be partially or wholly coupled to or combined with each other, and may be various technically linked or operated, and each of the embodiments may be implemented independently of each other or may be implemented together in a related relationship.

FIG. 1 is a cross-sectional view of a copper foil 110 according to one embodiment of the present disclosure.

Referring to FIG. 1, the copper foil 110 of the present disclosure includes a copper film 111 including 99.9 wt % or more of copper and a protective layer 112 formed on the copper film 111. In the copper foil 110 illustrated in FIG. 1, the protective layer 112 is formed on each of both surfaces of the copper film 111, but the embodiments of the present disclosure are not limited thereto. The protective layer 112 may be formed only on one surface of the copper film 111.

The copper film 111 may be formed on a rotating anode drum through electroplating, and has a shiny surface that is in direct contact with the rotating anode drum in the electroplating process and a matte surface opposite to the shiny surface.

The protective layer 112 is formed by electrodepositing an anticorrosion material on the copper film 111. The anticorrosion material may include at least one of a chromium compound, a silane compound, and a nitrogen compound. The protective layer 112 prevents oxidation and corrosion of the copper film 111 and improves heat resistance, thereby increasing a lifespan of a final product including the copper foil 110 as well as a lifespan of the copper foil 110 itself.

According to one embodiment of the present disclosure, the copper foil 110 has a room temperature water contact angle in a range of 60° to 70°. The term “room temperature water contact angle” used herein refers to a water contact angle measured at room temperature. Specifically, the room temperature water contact angle refers to a water contact angle measured on a surface of the copper foil 110 at 25° C.

When the room temperature water contact angle of the copper foil 110 exceeds 70°, an active material layer 120 may not be properly coated on the copper foil 110 and adhesive strength therebetween may be reduced. When the active material layer 120 is not properly coated, conductivity may be reduced.

In addition, when the room temperature water contact angle of the copper foil 110 is less than 60°, the surface of the copper foil 110 may be highly polarized, which may result in moisture adsorption. Accordingly, the ability to protect the surface of the copper foil 110 from the atmosphere or moisture may be reduced, and the surface may be oxidized or discolored during storage or transportation.

According to one embodiment of the present disclosure, the copper foil 110 has a room temperature surface resistivity in a range of 2.4 mΩ/cm to 2.7 mΩ/cm. The term “room temperature surface resistivity” used herein refers to a surface resistivity measured at room temperature. Specifically, the room temperature surface resistivity refers to a surface resistivity measured at 25° C.

When the room temperature surface resistivity of the copper foil 110 exceeds 2.7 mΩ/cm, the efficiency of a secondary battery using the copper foil 110 may be reduced due to the increased resistance. In addition, when the room temperature surface resistivity of the copper foil 110 exceeds 2.7 mΩ/cm, thermal energy during welding may be excessively consumed for the removal of an anticorrosion film because the thickness of the anticorrosion material itself may be excessive, and thus, there is a concern that a weld state with sufficient strength may not be achieved.

On the other hand, when the room temperature surface resistivity of the copper foil 110 is less than 2.4 mΩ/cm, the ability to protect the surface of the copper foil 110 from atmosphere or moisture at room temperature may be reduced, and the surface of the copper foil 110 may be easily oxidized or discolored during storage or transportation.

According to one embodiment of the present disclosure, the copper foil 110 has a water contact angle reduction rate of 0% to 25% after heat treatment at 190° C.for one hour.

When the water contact angle reduction rate of the copper foil 110 after heat treatment at 190° C. for one hour exceeds 25%, the change in water contact angle after heat treatment at 190° C. for one hour is large as compared to that in the room temperature water contact angle. When the change in water contact angle during heat treatment is large, the stability and conductivity of the copper foil 110 may be reduced during heat treatment.

According to one embodiment of the present disclosure, the copper foil 110 has a surface resistance increase rate of 0% to 5% after heat treatment at 190° C.for one hour.

When the surface resistance increase rate of the copper foil 110 after heat treatment at 190° C. for one hour exceeds 5%, the change in surface resistivity after heat treatment at 190° C. for one hour is large as compared to that in the room temperature surface resistivity. When the change in surface resistivity during heat treatment is large, the stability and conductivity of the copper foil 110 may be reduced during heat treatment.

The copper foil 110 according to one embodiment of the present disclosure has a thickness of 4 μm to 35 μm. The manufacture of a copper foil 110 having a thickness of less than 4 μm causes a decrease in workability. On the other hand, when the secondary battery is manufactured with a copper foil 110 having a thickness exceeding 35 μm, it becomes difficult to realize high capacity due to the thick copper foil 110.

According to one embodiment of the present disclosure, the copper foil 110 has an arithmetic mean roughness (Ra) of 0.1 μm to 0.3 μm.

When the arithmetic mean roughness (Ra) of the copper foil 110 is less than 0.1 μm, the adhesive strength between the copper foil 110 and the active material may be reduced.

On the other hand, when the arithmetic mean roughness (Ra) of the copper foil 110 exceeds 0.3 μm, the surface of the copper foil 110 becomes rough, and thus the active material may not be smoothly coated thereon.

Hereinafter, an electrode 100 including the copper foil 110 of the present disclosure and a secondary battery including the electrode 100 will be described in detail.

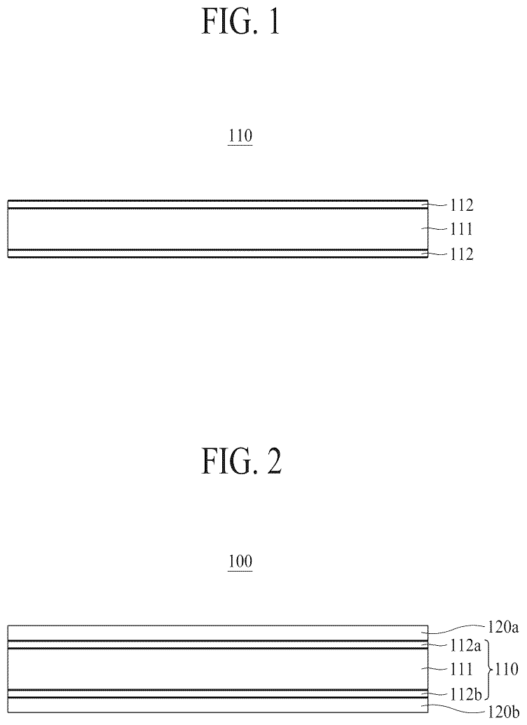

FIG. 2 is a cross-sectional view of an electrode for a secondary battery according to one embodiment of the present disclosure.

As illustrated in FIG. 2, the electrode 100 for a secondary battery according to one embodiment of the present disclosure includes the copper foil 110 of one of the above-described embodiments of the present disclosure and the active material layer 120.

FIG. 2 illustrates the active material layer 120 formed on each of both surfaces of the copper foil 110 as an example, but the present disclosure is not limited thereto, and the active material layer 120 may be formed only on one surface of the copper foil 110.

Generally, in a lithium secondary battery, an aluminum foil is used as a cathode current collector combined with a cathode active material, and the copper foil 110 is used as an anode current collector combined with an anode active material.

According to one embodiment of the present disclosure, the electrode 100 for a secondary battery is an anode, the copper foil 110 is used as an anode current collector, and the active material layer 120 includes an anode active material.

In order to secure a high capacity of a secondary battery, the active material layer 120 of the present disclosure may be formed of a composite of carbon and metal. The metal may include, for example, at least one of silicon (Si), germanium (Ge), tin (Sn), lithium (Li), zinc (Zn), magnesium (Mg), cadmium (Cd), cerium (Ce), nickel (Ni), and iron (Fe), and preferably, may include Si and/or Sn.

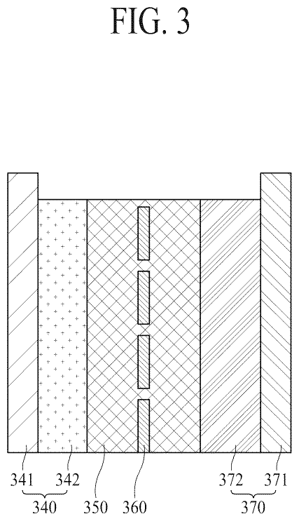

FIG. 3 is a schematic cross-sectional view of a secondary battery according to one embodiment of the present disclosure.

Referring to FIG. 3, the secondary battery includes a cathode 370, an anode 340, an electrolyte 350 disposed between the cathode 370 and the anode 340 to provide an environment in which ions can move, and a separator 360 electrically insulating the cathode 370 and the anode 340. Here, the ions moving between the cathode 370 and the anode 340 are, for example, lithium ions. The separator 360 separates the cathode 370 and the anode 340 in order to prevent charges generated at one electrode from being needlessly consumed by moving to another electrode through the inside of the secondary battery. Referring to FIG. 3, the separator 360 is disposed in the electrolyte 350.

The cathode 370 includes a cathode current collector 371 and a cathode active material layer 372, and an aluminum foil may be used as the cathode current collector 371.

The anode 340 includes an anode current collector 341 and an anode active material layer 342, and the copper foil 110 may be used as the anode current collector 341.

According to one embodiment of the present disclosure, the copper foil 110 disclosed in FIG. 1 may be used as the anode current collector 341. In addition, the electrode 100 for a secondary battery illustrated in FIG. 2 may be used as the anode 340 of the secondary battery illustrated in FIG. 3.

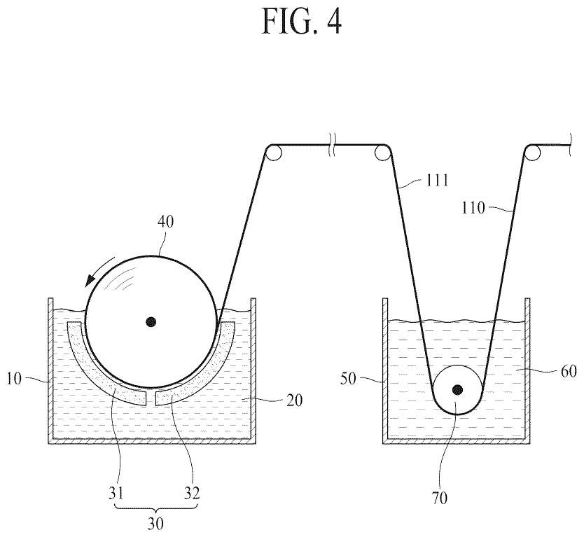

Hereinafter, a method for manufacturing the copper foil 110 of the present disclosure will be described in detail with reference to FIG. 4.

The method for manufacturing the copper foil 110 of the present disclosure includes forming a copper film 111, and forming a protective layer 112 on the copper film 111.

The method of the present disclosure includes forming the copper film 111 on a rotating anode drum 40 by electrically connecting a cathode plate 30 and the rotating anode drum 40, which are disposed to be spaced apart from each other in an electrolyte 20 in an electrolytic bath 10.

As illustrated in FIG. 4, the cathode plate 30 may include first and second cathode plates 31 and 32 electrically insulated from each other.

The forming of the copper film 111 may be performed by forming a seed layer through an electrical connection between the first cathode plate 31 and the rotating anode drum 40, and then growing a seed layer through an electrical connection between the second cathode plate 32 and the rotating anode drum 40.

A current density provided by each of the first and second cathode plates 31 and 32 may be 30 to 130 ASD (A/dm²).

When the current density provided by each of the first and second cathode plates 31 and 32 is less than 30 ASD, a surface roughness of the copper foil 110 is reduced, and thus the adhesion between the copper foil 110 and the active material layer 120 may not be sufficient.

On the other hand, when the current density provided by each of the first and second cathode plates 31 and 32 exceeds 130 ASD, a surface of the copper foil 110 may be rough, and thus the active material may not be smoothly coated.

According to one embodiment of the present disclosure, the electrolyte 20 is prepared by adding copper ions at a concentration of 70 g/L to 100 g/L, sulfuric acid at a concentration of 70 g/L to 150 g/L, chlorine (Cl) at a concentration of 1 ppm to 3 ppm, hydrogen peroxide at a concentration of 1 ml/L to 10 ml/L, lead ions (Pb²⁺) at a concentration of 1 ppm to 20 ppm, silver ions at a concentration of 0.1 ppm to 1 ppm, and cerium ions at a concentration of 2 ppm to 10 ppm.

According to one embodiment of the present disclosure, the content of lead ions (Pb²⁺) in the electrolyte 20 is 1 ppm to 20 ppm. Specifically, the concentration of lead ions (Pb²⁺) in the electrolyte 20 is managed at a concentration of 1 ppm to 20 ppm. In order to maintain the concentration of lead ions, a material that does not include lead may be used as a raw material input to the electrolyte 20. When the lead ions (Pb²⁺) are maintained at the concentration of 1 ppm to 20 ppm, the room temperature water contact angle according to the present disclosure may be maintained at 60° to 70°, and the room temperature surface resistivity may be maintained at 2.4 mΩ/cm to 2.7 mΩ/cm.

On the other hand, when the concentration of lead ions (Pb²⁺) is less than 1 ppm, a problem may occur where effectiveness is reduced in terms of maintaining the physical properties of the present disclosure. As a result, the room temperature water contact angle may fall outside the range of 60° to 70° and the room temperature surface resistivity may fall outside the range of 2.4 mΩ/cm to 2.7 mΩ/cm.

When the concentration of lead ions (Pb²⁺) exceeds 20 ppm, the lead ions (Pb²⁺) should be removed from the electrolyte 20 by using an ion exchange filter, and the surface roughness may be significantly increased because copper is non-uniformly precipitated. Accordingly, the room temperature water contact angle of the copper foil 110 may fall outside the range of 60° to 70°, and the room temperature surface resistivity may fall outside the range of 2.4 mΩ/cm to 2.7 mΩ/cm. In addition, as copper is non-uniformly precipitated, after heat treatment, the water contact angle may be excessively reduced or the surface resistivity may be excessively increased. According to one embodiment of the present disclosure, the content of silver ions in the electrolyte 20 is 0.1 ppm to 1 ppm.

When the concentration of silver (Ag) included in the electrolyte 20 is less than 0.1 ppm, the surface state of the copper foil 110 may become excessively poor, and thus the room temperature water contact angle of the copper foil 110 may fall outside the range of 60° to 70°, and the room temperature surface resistivity may fall outside the range of 2.4 mΩ/cm to 2.7 mΩ/cm.

On the other hand, when the concentration of silver (Ag) included in the electrolyte 20 exceeds 1.0 ppm, the surface state of the copper foil 110 may become excessively poor, and thus the room temperature water contact angle of the copper foil 110 may fall outside the range of 60° to 70°, and the room temperature surface resistivity may fall outside the range of 2.4 mΩ/cm to 2.7 mΩ/cm.

In order to adjust the concentration of silver (Ag) in the electrolyte 20, chlorine (Cl) may be input into the electrolyte 20. The chlorine (Cl) may precipitate the silver (Ag) in the form of a silver chloride (AgCl) compound such that the concentration of silver (Ag) in the electrolyte 20 may be adjusted. The silver chloride (AgCl) compound may be removed by filtration. According to one embodiment of the present disclosure, in order to adjust the concentration of silver (Ag) in the electrolyte 20, the content of chlorine (Cl) in the electrolyte 20 is maintained at 1 ppm to 3 ppm.

When the concentration of chlorine (Cl) is less than 1 ppm, the silver (Ag) ions are not removed well. On the other hand, when the concentration of chlorine (Cl) exceeds 3 ppm, an unnecessary reaction due to excessive chlorine (Cl) may occur, the copper film 111 that is electrodeposited on the rotating anode drum 40 may have a surface with sharp protrusions, and this surface provides an excellent environment for crystals to expand when the copper foil 110 is heat-treated. As a result, the room temperature water contact angle of the copper foil 110 may fall outside the range of 60° to 70°, and the room temperature surface resistivity may fall outside the range of 2.4 mΩ/cm to 2.7 mΩ/cm. In addition, due to the poor surface state, after heat treatment, the water contact angle may be excessively reduced or the surface resistivity excessively increased.

According to one embodiment of the present disclosure, the electrolyte 20 including an organic additive may further include hydrogen peroxide (H₂O₂). Due to the organic additive, organic impurities may be present in the electrolyte 20 that is continuously plated, and a content of carbon (C) in the copper foil may be appropriately adjusted by decomposing the organic impurities by treating the organic impurities with hydrogen peroxide (H₂O₂). As a concentration of total organic carbon (TOC) in the electrolyte 20 is increased, an amount of carbon (C) elements introduced into the copper film 111 is increased, which causes an increase in total amount of elements detached from the copper film 111 during heat treatment and thus causes a decrease in strength of the copper foil 110 after the heat treatment.

The hydrogen peroxide (H₂O₂) is added in an amount of 1 ml to 10 ml per one L of the electrolyte. Specifically, the hydrogen peroxide (H₂O₂) may be added in an amount of 2 ml to 8 ml per one L of the electrolyte. When the amount of added hydrogen peroxide (H₂O₂) is less than 1 ml/L, it is meaningless because there is little effect on the decomposition of organic impurities. When the amount of added hydrogen peroxide (H₂O₂) exceeds 10 ml/L, the organic impurities are excessively decomposed, and thus, the effect of inorganic additives such as cerium ions (Ce²⁺) is suppressed.

According to one embodiment of the present disclosure, the content of cerium ions in the electrolyte 20 is 2 ppm to 10 ppm.

When the content of cerium ions in the electrolyte 20 is less than 2 ppm, the tensile strength of the copper foil 110 is lowered, and when a final product with the copper foil 110 is manufactured through a roll-to-roll process, the risk of folding/curling is increased. In addition, the surface state of the copper foil 110 becomes poor, and as a result, the room temperature water contact angle of the copper foil 110 may fall outside the range of 60° to 70°, and the room temperature surface resistivity may fall outside the range of 2.4 mΩ/cm to 2.7 mΩ/cm.

On the other hand, when the cerium ion content in the electrolyte 20 exceeds 10 ppm, the improvement in terms of surface characteristics does not occur proportionally with the increase in cerium ion content. Thus, by adjusting the cerium ion content in the electrolyte 20 to the range of 2 ppm to 10 ppm, the performance of the copper foil 110 relative to manufacturing costs can be maximized.

According to one embodiment of the present disclosure, the electrolyte 20 is maintained at 48° C. to 60° C., and the current density provided by the cathode plate 30 may be 30 ASD to 130 ASD. When the copper film 111 is formed, a flow rate of the electrolyte 20 supplied into the electrolytic bath 10 may be 41 m³/hour to 45 m³/hour.

According to one embodiment of the present disclosure, when the copper film 111 is formed, the flow rate of the electrolyte 20 supplied into the electrolytic bath 10 may be 31 m³/hour to 46 m³/hour.

When the flow rate of the electrolyte 20 supplied into the electrolytic bath 10 is less than 31 m³/hour, as the flow rate is lowered, overvoltage increases and the copper film 111 is formed non-uniformly.

On the other hand, when the flow rate of the electrolyte 20 supplied into the electrolytic bath 10 exceeds 46 m³/hour, damage to the filter is induced, causing foreign substances to be introduced into the electrolyte.

The electrolyte 20 may have a flow rate of 31 m³/hour to 46 m³/hour. The electrolyte 20 may be circulated at the flow rate of 31 m³/hour to 46 m³/hour to remove solid impurities present in the electrolyte 20 during the process of forming the copper film 111 by electrodeposition and plating. In the process of circulating the electrolyte 20, the electrolyte 20 may be filtered. By removing impurities through such filtration, the cleanliness of the electrolyte 20 may be maintained.

The cleanliness of the electrolyte 20 may be maintained or improved by treating the electrolyte 20 with ozone or by inputting hydrogen peroxide and air into the electrolyte 20 while forming the copper film 111 through electroplating. The cleanliness of the electrolyte 20 may also be maintained or improved by filtering the electrolyte 20 through high-purity carbon having a TOC of less than 3 ppm when dispersed in distilled water to minimize organic impurities in the electrolyte 20.

In addition, the cleanliness of the electrolyte 20 may be maintained or improved by filtering the electrolyte 20 through high purity diatomaceous earth having a TOC of less than 5 ppm when dispersed in distilled water.

According to one embodiment of the present disclosure, when the copper film 111 is formed, it is preferable to maintain a content of TOC in the electrolyte 20 at 3 ppm or less. When the content of TOC exceeds 3 ppm, the grain growth of the copper film 111 may not be suppressed because an organic material is adsorbed on an active site of copper plating crystal growth, and as a result, a copper foil 110 having a room temperature surface resistivity in the range of 2.4 mΩ/cm to 2.7 mΩ/cm cannot be manufactured.

The surface of the rotating anode drum 40 affects an arithmetic mean roughness (Ra) of the shiny surface of the copper film 111. According to one embodiment of the present disclosure, the surface of the rotating anode drum 40 may be polished using a polishing brush having a grit of #800 to #1500.

The method of the present disclosure may further include immersing the copper film 111 in an anticorrosion solution 60. When the copper film 111 is immersed in the anticorrosion solution 60, the copper film 111 may be guided by a guide roll 70 disposed in the anticorrosion solution 60.

As described above, the anticorrosion solution 60 may include at least one of a chromium compound, a silane compound, and a nitrogen compound. For example, the copper film 111 may be immersed in a 1 g/L to 10 g/L potassium dichromate solution at room temperature for 1 to 30 seconds.

At least one anode active material selected from the group consisting of carbon, a metal (Me) of Si, Ge, Sn, Li, Zn, Mg, Cd, Ce, Ni or Fe, an alloy including the metal (Me), an oxide (MeOₓ) of the metal (Me), and a composite of the metal (Me) and carbon is coated on one surface or both surfaces the copper foil 110 of the present disclosure prepared through the method as described above to manufacture an electrode (i.e., anode) for a secondary battery of the present disclosure.

For example, 100 parts by weight of carbon for an anode active material, 1 to 3 parts by weight of styrene butadiene rubber (SBR), and 1 to 3 parts by weight of carboxymethyl cellulose (CMC) are mixed and prepared as a slurry using distilled water as a solvent. Subsequently, the slurry is applied on the copper foil 110 to a thickness of 20 μm to 60 μm using a doctor blade and pressed at 110° C. to 130° C. and at a pressure of 0.5 to 1.5 ton/cm².

A lithium secondary battery may be manufactured using the electrode (anode) for a secondary battery of the present disclosure manufactured through the method as described above, together with a conventional cathode, electrolyte and separator.

Hereinafter, the present disclosure will be described in detail with reference to examples and comparative examples. However, the examples described below are only intended to aid the understanding of the present disclosure, and the scope of the present disclosure is not limited to these examples.

### EXAMPLE 1

A copper film was formed on a rotating anode drum by electrically connecting a cathode plate and the rotating anode drum, which are disposed to be spaced apart from each other in an electrolyte in an electrolytic bath. The electrolyte included 88 g/L of copper ions, 105 g/L of sulfuric acid, 2.0 ppm of chlorine ions (Cl−), 5.0 ppm of hydrogen peroxide, 5.0 ppm of lead ions (Pb²⁺), 0.5 ppm of silver ions (Ag⁺), and 3.2 ppm of cerium ions (Ce²⁺). In the forming of the copper film, the electrolyte was maintained at about 50° C. A flow rate of the electrolyte supplied into the electrolytic bath was 43 m³/hour. A current density provided to form the copper film was 55 A/dm². The copper film was immersed in a 5 g/L potassium dichromate solution for 10 seconds at room temperature, and then a drying process was performed to form protective layers on both surfaces of the copper film, thereby completing a copper foil having a thickness of 5 μm.

### EXAMPLES 2 TO 4 AND COMPARATIVE EXAMPLES 1 TO 3

Concentrations of additives included in the electrolyte are as shown in Table 1 below. Copper foils were prepared as in Example 1, except for the concentrations of additives.

For the copper foils prepared according to Examples and Comparative Examples described above, water contact angles and surface resistivity were measured as follows, and the results are shown in Table 1 and Table 2.

TABLE 1

| | Electrolyte | | | | | | | | |
|---|---|---|---|---|---|---|---|---|---|
| | | Sulfuric | | Hydrogen | | | | Current | Electrolyte |
| | Cu | acid | Chlorine | peroxide | Lead | Silver | Ce²⁺ | density | temperature |
| | (g/L) | (g/L) | (ppm) | (ppm) | (ppm) | (ppm) | (ppm) | (ASD) | (° C.) |
| Example 1 | 88 | 105 | 2.0 | 5.0 | 5.0 | 0.5 | 3.2 | 55 | 50 |
| Example 2 | 88 | 105 | 2.2 | 7.0 | 5.0 | 0.6 | 3.2 | 55 | 50 |
| Example 3 | 88 | 105 | 1.8 | 7.0 | 10 | 0.8 | 5 | 55 | 50 |
| Example 4 | 88 | 105 | 2.5 | 3.0 | 15 | 0.3 | 3.2 | 55 | 50 |
| Comparative | 88 | 105 | 0.1 | 0.5 | 5.0 | 1.5 | 3.2 | 55 | 50 |
| Example 1 | | | | | | | | | |
| Comparative | 88 | 105 | 2.0 | 5.0 | 21 | 0.5 | 12.5 | 55 | 50 |
| Example 2 | | | | | | | | | |
| Comparative | 88 | 105 | 1.8 | 0.1 | 0.1 | 0.5 | 0.8 | 55 | 50 |
| Example 3 | | | | | | | | | |

TABLE 2

| | Room | Water | Water | | | |
|---|---|---|---|---|---|---|
| | temperature | contact | contact | Room | Surface | Surface |
| | water | angle | angle | temperature | resistivity | resistance |
| | contact | after heat | reduction | surface | after heat | increase |
| | angle | treatment | rate (%) | resistivity | treatment | rate (%) |
| Example 1 | 63.4 | 56.43 | 11 | 2.44 × 10⁻³ | 2.49 × 10⁻³ | 2.1 |
| Example 2 | 65.6 | 51.82 | 21 | 2.65 × 10⁻³ | 2.69 × 10⁻³ | 1.5 |
| Example 3 | 64.4 | 53.45 | 17 | 2.61 × 10⁻³ | 2.70 × 10⁻³ | 3.3 |
| Example 4 | 62.1 | 57.75 | 7 | 2.57 × 10⁻³ | 2.64 × 10⁻³ | 2.7 |
| Comparative | 59.7 | 41.19 | 31 | 2.31 × 10⁻³ | 2.43 × 10⁻³ | 5.3 |
| Example 1 | | | | | | |
| Comparative | 58.4 | 42.63 | 27 | 2.35 × 10⁻³ | 2.54 × 10⁻³ | 8.1 |
| Example 2 | | | | | | |
| Comparative | 70.8 | 46.02 | 35 | 2.71 × 10⁻³ | 2.98 × 10⁻³ | 10.1 |
| Example 3 | | | | | | |

For the copper foils prepared according to Examples 1 to 4 and Comparative Examples 1 to 3 as described above, i) room temperature water contact angle, ii) water contact angle after heat treatment, iii) water contact angle reduction rate, iv) room temperature surface resistivity, v) surface resistivity after heat treatment, and vi) surface resistance increase rate were checked.

Measurement of i) room temperature water contact angle and ii) water contact angle after heat treatment

The room temperature water contact angle of the copper foil 110 refers to a water contact angle measured at room temperature.

The water contact angle after heat treatment of the copper foil 110 refers to a water contact angle measured after heat treatment at 190° C.for one hour.

In this case, the water contact angle was measured according to a test method in accordance with ASTM D5946. Phoenix 300 from SEO (Surface Electro Optics) was used as a test device. The test was performed under test environment conditions of a temperature of 23±2° C.and a humidity (R.H.) of 45±5%.

The water contact angle after heat treatment was measured after heat treatment at 190° C. for one hour, that is, under the same conditions as the room temperature water contact angle other than the temperature.

### iii) Calculation of Water Contact Angle Reduction Rate

The water contact angle reduction rate refers to a ratio of a reduced water contact angle after heat treatment at 190° C. for one hour to the room temperature water contact angle.

### Measurement of iv) Room Temperature Surface Resistivity and iv) Surface Resistivity after Heat Treatment

The room temperature surface resistivity of the copper foil 110 refers to a surface resistivity measured at room temperature.

The surface resistivity after heat treatment of the copper foil 110 refers to a surface resistivity measured after heat treatment at 190° C. for one hour.

The surface resistivity of the copper foil 110 was measured according to ASTM D991 using MCP-T610 manufactured by Mitsubishi. In this case, the limit voltage was 10 V and a resistivity correction factor (RCF) was 4.185.

The surface resistivity after heat treatment was measured after heat treatment at 190° C. for one hour, that is, under the same conditions as the room temperature surface resistivity other than the temperature.

### v) Calculation of Surface Resistance Increase Rate

The surface resistance increase rate refers to a ratio of an increased surface resistivity after heat treatment at 190° C. for one hour to the room temperature surface resistivity.

Referring to Tables 1 and 2 above, the following results may be confirmed.

In the copper foil of Comparative Example 1 prepared using an electrolyte including chlorine and hydrogen peroxide in small amounts and silver ions in an excessive amount, the room temperature water contact angle did not satisfy 60° to 70°, and the room temperature surface resistivity did not satisfy 2.4 mΩ/cm to 2.7 mΩ/cm. In addition, the water contact angle reduction rate after heat treatment at 190° C. for one hour exceeded 25%, and the surface resistance increase rate after heat treatment at 190° C. for one hour exceeded 5%. As a result, the changes in the water contact angle and the surface resistivity after heat treatment were large, which reduced the conductivity of the copper foil.

In the copper foil of Comparative Example 2 prepared using an electrolyte including lead ions and cerium ions in excessive amounts, the room temperature water contact angle did not satisfy 60° to 70°, and the room temperature surface resistivity did not satisfy 2.4 mΩ/cm to 2.7 mΩ/cm. In addition, the water contact angle reduction rate after heat treatment at 190° C. for one hour exceeded 25%, and the surface resistance increase rate after heat treatment at 190° C. for one hour exceeded 5%. As a result, the changes in the water contact angle and the surface resistivity after heat treatment were large, which reduced the conductivity of the copper foil.

In the copper foil of Comparative Example 3 prepared using an electrolyte including hydrogen peroxide, lead ions, and cerium ions in small amounts, the room temperature water contact angle did not satisfy 60° to 70°, and the room temperature surface resistivity did not satisfy 2.4 mΩ/cm to 2.7 mΩ/cm. In addition, the water contact angle reduction rate after heat treatment at 190° C. for one hour exceeded 25%, and the surface resistance increase rate after heat treatment at 190° C. for one hour exceeded 5%. As a result, the changes in the water contact angle and the surface resistivity after heat treatment were large, which reduced the conductivity of the copper foil.

On the other hand, all the copper foils of Examples 1 to 4 according to the present disclosure satisfied values within the above standard ranges, and as a result, the conductivity of the copper foil was not reduced.

According to the present disclosure, a copper foil with improved conductivity can be manufactured, and intermediate parts and final products, such as flexible printed circuit boards (FPCBs) and secondary batteries, can be manufactured using the copper foil, so that productivity of the intermediate parts as well as the final products can be improved.

### DESCRIPTION OF REFERENCE NUMERALS

100: electrode for second battery
110: copper foil
111: copper film
120: active material layer
10: electrolytic bath
20: electrolyte

What is claimed is:

1. A copper foil comprising:
a copper film including 99.9 wt % or more of copper; and
a protective layer formed on the copper film,
wherein the copper foil has a room temperature water contact angle in a range of 60° to 70°, and a room temperature surface resistivity in a range of 2.4 mΩ/cm to 2.7 mΩ/cm.

2. The copper foil of claim 1, wherein the copper foil has a water contact angle reduction rate after heat treatment at 190° C.for one hour in a range of 0% to 25%.

3. The copper foil of claim 1, wherein the copper foil has a surface resistance increase rate after heat treatment at 190° C.for one hour in a range of 0% to 5%.

4. The copper foil of claim 1, wherein the copper foil has an arithmetic mean roughness (Ra) of 0.1 μm to 0.3 μm.

5. The copper foil of claim 1, wherein the protective layer includes at least one of a chromium compound, a silane compound, and a nitrogen compound.
